(19) United States
(12) Patent Application Publication
(10) Pub. No.: US 2004/0202789 A1
(43) Pub. Date: Oct. 14, 2004

(54) Process for preparing thin film solids

(75) Inventors: Kashinath Rangu Patil, Pune (IN); Prakash Dinkar Godbole, Pune (IN); Anand Balwant Mandale, Pune (IN)

Correspondence Address: LADAS & PARRY, 26 WEST 61ST STREET, NEW YORK, NY, 10023, US

(73) Assignee: COUNCIL OF SCIENTIFIC AND INDUSTRILA RESEARCH

(21) Appl. No.: 10/403,811

(22) Filed: Mar. 31, 2003

(51) Int. Cl. B05D 3/02

(52) U.S. Cl. 427/372.2; 427/430.1

(57) ABSTRACT

The present invention provides aprocess for the preparation of thin films which comprises of making a solution of the material or the precursor of the material in a solvent and spinning the solution in novel assembly, in the process removing the solvent and forming a file Further these films are allowed in contact with another liquid to get desired material on the substrate, as mentioned hereinbelow.

a) Preparing an aqueous/nonaqueous solution containing cations/anions or species of corresponding elements leading too the formation of the compound.

b) Applying the spin-on procedure to the tandem for a time so that the solvent is completely removed and the film is formed on the substrate.

c) Allowed the deposited film in contact with a liquid/solvent/solution for sufficient time,

d) Processing the film, chemically and/or thermally.

e) Repeating the procedure for increasing the thickness of the film, if necessary.

### FIELD OF THE INVENTION

The present invention relates to an improved process for the preparation of thin films solids. More particularly the process of the invention relates to the preparation of films of solids such as inorganic, organic and organo-inorganic solids. Still more particularly the solids are exemplified by but not limited to metals, metal halides, oxides and chalcogenites. The film formed is useful for optics, electronics and sensors. The particle size of the films formed is in the range of nanometers.

### BACKGROUND OF THE INVENTION

Conventional methods employed for the formation of thin films are

1) Sol-gel method

2) Vacuum Evaporative technique

3) Glow discharge technology

4) Plasma process

5) Chemical vapour deposition

6) Electroplating

7) Spray pyrolysis

8) Langmuir Blodgett method

9) Self assembled multilayers

10) Liquid liquid interface reaction technique (LLIRT)

11) Conventional spin-on coating method

12) Improved spin coating process

The above mentioned methods and their drawbacks are discussed below.

1. Sol-gel method: Molecular or atomic conglomerates when stabilize in a suspended state in an aqueous liquid is called sol. These conglomerates or suspensions can be destabilized to aggregated particles or homogeneous gel by changing the conditions of solvation or suspension in sots. If the said molecular or atomic conglomerates are desired to be deposited in the form of a uniform film during gelation, a substrate, glass plate or quartz plate or the like is dipped in a sol and drawn, out. A thin coating of gel is formed. The substrate is then dried, The heat treatment of substrate leads to desired coating.

Drawbacks: The conditions of sol stabilization and gelation are very critical. Also, thickness control is difficult. During the drying of gel and post deposition heat treatment, large volume changes bring about cracks in gel material and therefore it is difficult to get homogeneous, uncracked films.

2. Vacuum evaporative technique: The substance of which a thin film is to be deposited is generated in vapour state by boiling, sublimating or vaporizing by giving sufficient energy by heating, electron beam bombardment, laser or any other energy source In the second step vapour is transported to substrate without any chemical change occurring i the substance and in the last step, the substance is allowed to condense/deposit on substrate surface such as glass/quartz plate, silicon wafer etc.

Drawbacks:—High vacuum is required. Some chemical changes in Substance composition is quite common such as nonstoichiometry or contamination from source, container. For the uniform and adherent films to be obtained, the number of parameters is large and therefore process monitoring and control is needed. Molecular beam epitaxy, which is an improved technology over vacuum evaporation, is mainly used for growing single crystalline films (very ordered films) on single crystal substrates. The cost and number of parameters are increased many fold. The Operation is complex and thoughput is very low.

3. Glow discharge technology: The ejection of surface ions from an electrode surface by momentum transfer from bombarding ion, is called sputtering. In other words during sputtering process source of electrode material in vapour state is made available, which is used for thin film formation as in vacuum evaporation. There are various ways in which basic process is modified AC sputtering, bias sputtering, magnetron sputtering are often used modifications.

Drawback: The main drawback is contamination problem. Also, the equipment is sophisticated and very costly.

4. Plasma processes:—Some chemical reactions are accelerated in presence of bombarding reactive ions. Therefore, the electrode material (metal) in presence of gases like O2, N2+H2, CH4, forming a glow discharge forms a, film of metal oxide, carbide, nitride on the substrate surface. The plasma can be generated by means of discharge in vacuum, electron bombardment, cyclotron resonance etc.

Drawback: The drawback of this process is again high cost equipment. Also, limited number of reactions can be carried out to formed thin films by this method.

5. Chemical vapour deposition (CVD):—In this method the constituents of vapour phase are made to react near or on the substrate surface where the solid product is obtained in thin film form. Since large number of reactions are available, CVD is versatile and flexible technique in producing variety of products (oxides, sulphides, selenides etc.) in thin film form including metals, semiconductors, insulators. Metal-organic are very convenient for CVD application as relatively low temperatures, can transform them in vapour phase, compared to pure inorganic compounds. This, therefore has become a main modification of CVD called MOCVD. As a modification of CVD, other energy sources assistance is taken to carry out reactions by increasing the reaction rates. The lasers, photons are utilized for this purpose.

Drawback: Although the chemistry part of CVD appears to be simple, monitoring of many parameters is needed to achieve films of good quality. The process, therefore, becomes technically complicated and critical. Also, thickness control of films is difficult.

6. Electroplating: When a current is passed through a conducting solution (electrolyte) and suitable reactions are taking place at either cathode i.e. negative electrode or anode i.e., positive electrode, it is possible to employ this method in depositing thin films on conducting substrates, By controlling the pH, current density, temperature, composition of electrolyte, it is possible to get uniform films of metals, some metal oxides, chalcogenides etc.

Drawbacks; Films are obtained only on the conducting substrates. Also, the contamination is a common problem as many reactions can take place simultaneously.

7. Spray pyrolysis:—The atomized droplets of a solution are sprayed on hot substrate where pyrolysis takes place, leading to a film on the substrate surface. Although versatile, this method is not useful for making ultrathin films.

8. Langmuir Blodgett method:—In this method a known quantity (1X1O-3 to IxlO-4M) of a solution of film forming materials such as fatty acids or amines dissolved in volatile solvents such as benzene, chloroform, carbon tetrachloride etc. is spread on a known area of clean water surface held in Langmuir trough fitted with film pressure balance. These materials form monomolecular films at air-water interface, on lateral compression of the film with help of barrier or oil piston (such as oleic acid) condensed phase is obtained. If the soluble metal salts are added in aqueous subphase the cations/or (anions) get attached to the acid/(or amine) groups at the surface. The deposition of a monolayer on to a solid substrate such as glass plate, quartz plate, silicon wafer etc. is effected by introducing the substrate inside the aqueous subphase. For every withdrawal or dipping of the substrate one monolayer is deposited. Usually the dipping or withdrawal is effected under constant pressure (15 to 35 dynes/cm.). The nature and the amount of the species deposited from the aqueous subphase depend on deposition condition such as concentrations, pH, rate of dipping and withdrawal deposition pressure etc.. By varying the deposition parameters the optimal condition for the deposition of metal ion is obtained. The deposited fi ms are then thermally decomposed (500-900° C.) to get stable oxide films. The thickness of the film can be controlled by the number of monolayer deposited.

Drawbacks: Only limited number of cations or anions could be brought in the film to react and to give desired product. Also, in the post deposition treatment, the long chain carbon containing part is to be removed mainly by burning. This leaves some chances of carbon contamination in the films. Also, the chemical reduction of the film material by carbon during heat treatment is possible.

9. Self assembled multilayers:—In principal, it is a construction of, multilayers assemblies by consecutive adsorption of anionic and cationic bipolar amphiphyles and! or polyelectrolytes; the driving force being the attraction between the opposite charges. In a modification Van-der-wall interactions have been used as driving force.

Drawbacks: The disadvantages of this method that, many chemical species, other than substrate and the material of which the film is to be deposited are involved. Post deposition treatment is required to remove unwanted species.

10. Liquid liquid interface reaction technique (LLIRT):—A reaction of solute species at the interface of aqueous and nonaqueous solvents forms a solid product on aqueous surface. The product can be of desired material or its precursor. This solid product when compressed laterally forms an ultrathin film which can be taken on solid substrate by well known Langmuir Blodgett technique. Oxides, chalcogenides, halides and other material thin Elms can be formed by this technique.

Drawback: The films formed are of very small thickness and needs several repetitions for increasing the thickness. Adjusting conditions suitable for the reaction is another limitation.

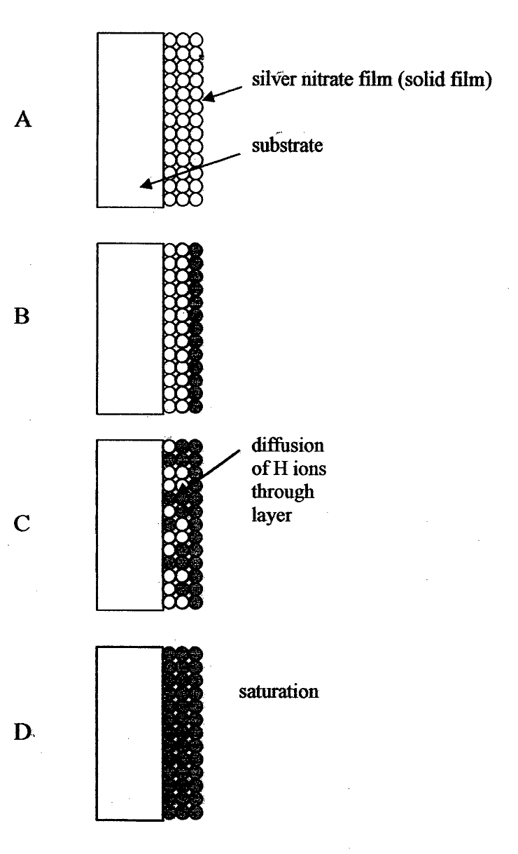

11. Conventional spin-on coating method:—In a conventional spin on coating method of depositing thin films, a drop of solution or sol (1) FIG. 1 is placed on rotating substrate. By centrifugal force the sol/solution is spread, on the surface of the substrate where the gelation takes place as explained in the sol-gel technique. Further heating the substrate converts the gel film into desired film (2) FIG. 1.

Drawback: The method can be used for the deposition of specific materials only. Also, monitoring of the thickness of the films is difficult. The viscosity of spinning solution is of vital importance, which limits its applications to specific reactions. The above methods and their drawbacks are discussed in our earlier patent for filing in Indian Patent office number 164/DEL/2002 dated 28 Feb. 2002.

12. Improved spin coating process: In an improved spin coating process, a drop of an aqueous/nonaqueous salt solution is placed between the two substrate or plates so that the surface of the substrate fully comes in contact with the solution. Then spinning the assembly with high number of RPM so that the axis of rotation passes though the center of substrate for the duration such that solvent is removed completely forming a film on the substrate. Then process the film chemically and/or thermally, if necessary.

Drawbacks: The drawback of this technique is that spin-coating process is applied to deposit crystalline film of precursors which needs to be heat treated to get desired oxide films. Such a treatment leads to grain growth jeopardizing the preparation of nanofilms, which are presently considered for important applications.

### OBJECTS OF THE INVENTION

The main object of the present invention is to provide an improved coating process for the preparation of thin films of inorganic and organic compounds and composites thereof

Another object of the invention is to provide the process to grow thin films by solid-liquid reaction.

### SUMMARY OF THE INVENTION

The principle by which the process of present invention is developed is based on (a) Depositing thin films of organic/inorganic materials on a substrate (b) allowing the deposited film to be in contact with a liquid/solvent/solution, for example, by dipping the substrate in the said liquid/solvent/solution for sufficient time (c) processing the resulting film on the substrate chemically/thermally if necessary to obtain desired, films.

Accordingly, the present invention provides an improved process for the preparation of thin solid films of inorganic/organic/composite materials which comprises, depositing thin films of a precursor of the solid of which the film is desired, on a substrate by conventional methods, dipping the film along with the substrate in a liquid reactant, transforming it to a film of a solid of which the final film is desired or its precursors, optionally subjecting the resulting films to chemical/thermal treatment to obtain the final product.

In one embodiment of the invention the precursors is selected from inorganic compounds such as nitrates, citrates, chlorides, oxalates, carbonates, sulphates of Ag, Ti, Pt, Sn, Fe, Co, Ni, Cu, Cd, Cr, AI, V, Zr, Nb, Mo, Pd, In, Ca, Sr, Ba, Pb, Ta, W, Ce and the mixtures thereof and/or organic precursors.

In another embodiment, the liquid reactant is a solvent or a solution or mixture thereof.

In another embodiment the reactant liquid is a solution wherein the solutes are chosen from hydrogen sulphide, alkali metal sulphides, ammonium sulphide, alkalimetal hydroxide, tetraethyl/methyl/propyl ammonium hydroxide, selino urea, potassium titanyl oxalate etc.

In another embodiment the solvent used in the present invention are selected from water, alcohol, carbon tetra chloride, benzene, hexane, ethylene glycol etc.

In yet another embodiment, the substrates used in the process of present invention are selected from glass, quartz, alumna, mica, polymers, pellets of oxides of MgO, ZrO2, ZnO, and sodium chloride.

In still another embodiment the concentration of react solution is in the range of 0.1 to 5M.

In a feature of the present invention the methods used for depositing the films of salts used in the process of invention is selected from vacuum evaporation and its (modifications, Glow discharge technique, spin coating and improved spin coating.

In another feature of the invention, the films formed by the present invention consist of nanoparticulate nature. The chemical processing of the film can be brought about at various temperatures to obtain the desired physical features such as particle size, morphology etc. of the film. In yet another feature, the film with desired thickness can be formed.

### BRIEF DESCRIPTION OF THE INVENTION

FIG. 1 is a schematic of the mechanism of the invention illustrating the four stages of the film formation.

### DETAILED DESCRIPTION OF THE INVENTION

The principle by which the process of present invention is developed is based on (a) Depositing thin films of organic/inorganic materials on a substrate (b) allowing the deposited film to be in contact with a liquid/solvent/solution, for example, by dipping the substrate in the said liquid/solvent/solution for sufficient time (c) processing the resulting few on the substrate chemically/thermally if necessary to obtain desired, films.

The present invention provides an improved process for the preparation of thin solid films of inorganic/organic/composite materials which comprises, depositing thin films of a precursor of the solid of which the film is desired, on a substrate by conventional methods, dipping the film along with the substrate in a liquid reactant, transforming it to a film of a solid of which the final film is desired or its precursors, optionally subjecting the resulting films to chemical/thermal treatment to obtain the final product.

The precursors are is selected from inorganic compounds such as nitrates, citrates, chlorides, oxalates, carbonates, sulphates of Ag, Ti, Pt, Sn, Fe, Co, Ni, Cu, Cd, Cr, AI, V, Zr, Nb, Mo, Pd, In, Ca, Sr, Ba, Pb, Ta, W, Ce and the mixtures thereof and/or organic precursors.

The liquid reactant is a solvent or a solution or mixture thereof In another feature of the invention, the reactant liquid is a solution wherein the solutes are chosen from hydrogen sulphide, alkali metal sulphides, ammonium sulphide, alkalimetal hydroxide, tetraethyl/methyl/propyl ammonium hydroxide, selino urea, potassium titanyl oxalate etc.

The solvent used in the present invention are selected from water, alcohol, carbon tetra chloride, benzene, hexane, ethylene glycol etc. The substrates used in the process of present invention are selected from glass, quartz, alumina, mica, polymers, pellets of oxides of MgO, ZrO2, ZnO, and sodium chloride, the concentration of reactant solution is preferably in the range of 0.1 to 5M.

In a feature of the present invention the methods used for depositing the films of salts used in the process of invention is selected from vacuum evaporation and its (modifications, Glow discharge technique, spin coating and improved spin coating.

In another feature of the invention, the films formed by the present invention consist of nanoparticulate nature. The chemical processing of the film can be brought about at various temperatures to obtain the desired physical features such as particle size, morphology etc. of the film. In yet another feature, the film with desired thickness can be formed.

Referring now to FIG. 1 which provides a schematic of the mechanism of the invention illustrating the four stages of the film formation; the four stages are:.

Stage A: Salt solution film formed by known techniques on the substrate

Stage B: The film deposited on the substrate dipped in a liquid/solvent/solution. (The spontaneous formation of overIayer.)

Stage C: Diffusion of desired species from liquid/solvent/solution through overlayer to extend the reaction into bulk. (time<time optimum)

Stage D: Completion of reaction to obtained desired product or its precursor (time−optimum)

The invention is further illustrated by the examples given below which would not be construed to limit the scope of present invention.

### EXAMPLE 1

A solution of silver nitrate in the concentration 0.1 to 5 M in water is prepared. The glass plate is deposited with the silver nitrate using improved spin-on coating process with rpm equal to 2000 for 30 seconds. The Elm on glass substrate is dipped in the hydrazine hydrate solution/sodium borohydride solution in the concentration range 0.01 to 0.0001 M in water for 2 to 10 minutes. The dried film is characterized as silver film by XRD and XPS having particle size in the range 2 to 50 nm characterized by transmission electron |microscope (TEM).

### EXAMPLE 2

Cadmium chloride is deposited on glass substrate by flash evaporation. The thickness of the film is in the rage of 1 000 micron. The film is characterized by XRD. The film is dipped in hydrogen sulphide solution in water for 5 minutes. The resulting film is characterized as CdS by XRD, XPS having a particle size in the range 2 to 50 nm.

### EXAMPLE 3

A solution of zirconyl nitrate (3M aqueous solution) is deposited on quartz substrate by modified spin coating with spinning at 2500 rpm for 45 seconds. The film formed is then dipped in ammonia solution having pH 10 for 10 minutes. The film is thus obtained is subjected to calcination at a temperature of 750° C. for 4 hours. XRD and XPS characterize the resulting film as ZrO2.

The Main Advantages of the Present Invention are

1) Films of both organic and inorganic materials can be deposited.

2) No sophisticated equipment is required for the application of this method.

3) The method consists of simple operations and parameters can be easily monitored.

4) The thickness of the film obtained by this method can be monitored.

1.-11 (canceled).

12. A process for the preparation of a solid film of a composite material, wherein the solid film is formed of nanoparticles, the process comprising the steps of:
(a) depositing a film of a precursor of the composite material on a substrate, said precursor comprising a salt of Ag, Ti, Pt, Sn, Fe, Co, Ni, Cu, Cd, Cr, A1, V, Zr, Nb, Mo, Pd, In, Ca, Sr, Ba, Pb, Ta, W, or Ce;
(b) contacting the film with a liquid reactant so as to transform the film into a composite film that, upon treatment in step (c), results in the solid film of the composite material; and
(c) subjecting the composite film to a chemical and/or thermal treatment to obtain the solid film of the composite material wherein the solid film is formed of nanoparticles.

13. The process according to claim 12, wherein the salt is a nitrate, citrate, chloride, oxalate, carbonate, sulfate or a mixture thereof.

14. The process according to claim 12, wherein the salt is an organic salt.

15. The process according to claim 12, wherein the liquid reactant is deposited as a solvent or solution.

16. The process according to claim 12, wherein the liquid reactant is a solution comprising a solute selected from the group consisting of hydrogen sulfide, alkali methyl sulfide, ammonium sulfide, alkali metal hydroxide, tetraethyl ammonium hydroxide, methyl ammonium hydroxide, propyl ammonium hydroxide, selino urea and potassium titanyl oxalate.

17. The process according to claim 12, wherein the liquid reactant is present in a solvent selected from the group consisting of water, alcohol, carbon tetra chloride, benzene, hexane and ethylene glycol.

18. The process according to claim 12, wherein the substrate is selected from the group consisting of glass, quartz, alumina, mica, polymers, pellets of oxides of MgO, ZrO₂, ZnO and sodium chloride.

19. The process according to claim 12, wherein the liquid reactant is present in a solution in a concentration of 0.1 to 5M.

20. The process according to claim 12, wherein the depositing of the film in step (a) is by vacuum evaporation, glow discharge or spin coating.

21. The process according to claim 12, wherein the liquid reactant comprises a solvent which is an alkyl alcohol.

22. The process according to claim 12, wherein the liquid reactant is an aqueous solution of Na₂S.

23. The process according to claim 12, wherein step (b) comprises inserting the film along with the substrate in the liquid reactant.

24. The process according to claim 23, wherein the film and substrate are inserted in the liquid reactant for a period of from 2 to 10 minutes.

25. The process according to claim 12, wherein the treatment in step (c) consists of drying the composite film.

26. The process according to claim 12, wherein the treatment in step (c) consists of calcining the composite film.

27. The process according to claim 12, wherein the solid film of the composite material consists of particles in a size range of 2 to 50 nm.
